(19) United States
(12) Patent Application Publication
(10) Pub. No.: US 2024/0337627 A1
(43) Pub. Date: Oct. 10, 2024

(54) SYSTEM AND METHOD FOR FAST MICROSCOPY

(71) Applicant: Onto Innovation Inc., Wilmington, MA (US)

(72) Inventors: Manjusha MEHENDALE, Morristown, NJ (US); George Andrew ANTONELLI, Flanders, NJ (US); Nigel P. SMITH, Hillsboro, OR (US); Marco ALVES, Newark, NJ (US); Mahboobe JASSAS, Budd Lake, NJ (US)

(73) Assignee: Onto Innovation Inc., Wilmington, MA (US)

(21) Appl. No.: 18/627,318

(22) Filed: Apr. 4, 2024

Related U.S. Application Data
(60) Provisional application No. 63/495,034, filed on Apr. 7, 2023.

(51) Int. Cl. G01N 29/24; G01N 21/55; G01N 29/04

(52) U.S. Cl. CPC G01N 29/2418; G01N 21/55; G01N 29/045; G01N 2291/0289

(57) ABSTRACT

A time resolved reflectivity metrology device images structures underlying layers using a pulsed pump beam and pulsed probe beam with at least one time delay between the pulses. One or both beams are modulated. A camera with a multi-pixel array and independent phase locking for each pixel in the multi-pixel array receives and demodulates the reflected probe beam to generate images. The camera may record a change in reflectivity or surface deformation of the target sample at every pixel as a function of at least one time delay between the pump pulses and the probe pulses, with which at least one property of the target sample may be characterized.

### CROSS REFERENCE TO RELATED APPLICATIONS

This application claims priority under 35 U.S.C. § 119 to U.S. Provisional Application No. 63/495,034, filed Apr. 7, 2023, entitled “A SYSTEM AND METHOD FOR FAST MICROSCOPY,” which is assigned to the assignee hereof and is incorporated herein by reference in its entirety.

### FIELD OF THE DISCLOSURE

The subject matter described herein is related generally to microscopy, and more particularly to the use of time resolved reflectivity measurements.

### BACKGROUND

Semiconductor processing for forming integrated circuits requires a series of processing steps. These processing steps include the deposition and patterning of material layers such as insulating layers, polysilicon layers, and metal layers. The material layers are typically patterned using a photoresist layer that is patterned over the material layer using a photomask or reticle. Typically, the photomask has alignment targets or keys that are aligned to fiduciary marks formed in the previous layer on the substrate. The overlay and alignment of a lithographically defined pattern on top of the underlying pattern is fundamental to device operation in all multi-layer patterned process flows. Misalignment between layers or patterns may lead to device failure.

There are various optical techniques and specially designed targets that are conventionally used for alignment and overlay measurements. For example, conventional imagining techniques may use specific wavelengths of light, e.g., ultraviolet (UV), visible, or infrared (IR), to image the underlying structures with which the overlying layer is to be aligned. However, in the fabrication of some structures, intervening optically opaque layers may be present. Optically opaque materials, such as found in semi-damascene process flow or after the processing of the magnetic tunnel junction (MTJ) of a magnetic random-access memory (MRAM), may be present between target structures, which presents particular challenges for alignment and overlay control. The presence of intervening opaque materials, for example, typically requires extra patterning operations for measurement thereby adding significant process cost.

Other processing steps may produce other types of underlying structures, including desired structures or undesired structures. For example, some processing steps may produce inclusions or voids within layers or between layers. The detection of the presence of underlying structures may be desirable during the fabrication process.

Microscopy techniques using non-optical methods for detection or measurement of structures including desired structures, such as alignment or overlay structures, or undesired structures, such as inclusions or voids, buried under one or more layers are therefore desirable.

### SUMMARY

A time resolved reflectivity metrology device may be used to image structures underling layers using a pulsed pump beam and pulsed probe beam with different time delays between the pulses. One or both beams are modulated. A camera with a multi-pixel array and independent phase locking for each pixel in the multi-pixel array receives and demodulates the reflected probe beam to generate images. The camera may record a change in reflectivity or surface deformation of the target sample at every pixel as a function of at least one time delay between the pump pulses and the probe pulses, with which at least one property of the target sample may be characterized.

In one implementation, a metrology device for non-destructive metrology of a sample includes a light source for generating pulsed light, a pump arm, and a probe arm. The pump arm is configured to receive at least a first portion of the pulsed light and irradiate the sample with a pump beam having at least one pump pulse to cause transient perturbation in material in the sample and the probe arm that is configured to receive at least a second portion of the pulsed light and irradiate the sample with a probe beam having at least one probe pulse to produce a reflected probe beam that is modulated based on the transient perturbation in the material in the sample. At least one modulator modulates at least the at least one pump pulse in the pump beam. The metrology device includes a camera configured to receive and demodulate the reflected probe beam to generate images of the sample, wherein each image is a function of at least one time delay between the at least one pump pulse and the at least one probe pulse. The camera is configured for parallel acquisition of transient signals from the images of the sample using a multi-pixel array and independent phase locking for each pixel in the multi-pixel array to generate the images. The camera records a change in reflectivity or surface deformation of the sample at each pixel as the function of the at least one time delay between the at least one pump pulse and the at least one probe pulse. At least one processor coupled to the camera and configured to measure at least one property of the sample based on a recorded reflectivity or surface deformation of the sample at each pixel as the function of the time delay between the at least one pump pulse and the at least one probe pulse.

In one implementation, a method for non-destructive metrology of a sample, includes generating pulsed light, irradiating the sample with a pump beam produced with at least a first portion of the pulsed light, the pump beam having at least one pump pulse to cause transient perturbation in material in the sample; and irradiating the sample with a probe beam produced with at least a second portion of the pulsed light, the probe beam having at least one probe pulse, to produce a reflected probe beam that is modulated based on the transient perturbation in the material in the sample. At least the pump pulse in the pump beam is modulated. The method includes receiving and demodulating the reflected probe beam with a camera to generate images of the sample, wherein each image is a function of at least one time delay between the at least one pump pulse and the at least one probe pulse. The camera is configured for parallel acquisition of transient signals from the images of the sample using a multi-pixel array and independent phase locking for each pixel in the multi-pixel array to generate the images. The camera records a change in reflectivity or surface deformation of the sample at each pixel as the function of the at least one time delay between the at least one pump pulse and the at least one probe pulse. The method includes measuring at least one property of the sample based on a recorded reflectivity or surface deformation of the sample at each pixel as the function of the time delay between the at least one pump pulse and the at least one probe pulse.

### BRIEF DESCRIPTION OF THE DRAWINGS

FIG. 1 illustrates a block diagram of a time resolved reflectivity metrology device that uses a camera that is configured for parallel acquisition of transient signals using a multi-pixel array and independent phase locking for each pixel in the multi-pixel array.

FIG. 2 illustrates another schematic representation of a time resolved reflectivity metrology device that uses a camera that is configured for parallel acquisition of transient signals using a multi-pixel array and independent phase locking for each pixel in the multi-pixel array.

FIG. 3 illustrates a schematic representation of a camera configured for parallel acquisition of transient signals using a multi-pixel array and independent phase locking for each pixel in the multi-pixel array.

FIG. 4A illustrates measurement of a buried structure in the form of a metal structure in a sample using parallel acquisition of transient signals using a multi-pixel array and independent phase locking for each pixel in the multi-pixel array.

FIG. 4B illustrates measurement of a buried structure in the form of void in a sample using parallel acquisition of transient signals using a multi-pixel array and independent phase locking for each pixel in the multi-pixel array.

FIG. 5 is a flow chart illustrating a process of non-destructive time resolved reflectivity metrology of a target on a sample with a camera configured for parallel acquisition of transient signals using a multi-pixel array and independent phase locking for each pixel in the multi-pixel array.

### DETAILED DESCRIPTION

Fabrication of semiconductor and similar devices requires a series of processing steps in which layers, such as insulating layers, polysilicon layers, and metal layers, are deposited and patterned. For proper operation of such devices, proper overlay and alignment of successive layers is sometimes crucial. During the fabrication process, non-destructive metrology techniques are used to ensure proper alignment and overlay, using specially designed targets.

Targets used for alignment and overlay consist of structures assigned to each layer, e.g., a bottom layer and a top layer. A target may be imaged and the relative position of the top structure with respect to the bottom structure may be determined from the image. The relative positions of the top and bottom structures provide an indication of the alignment or overlay of their respective layers. To conventionally image a target, light having wavelengths that can penetrate the sample to the bottom layer is used. For example, depending on the material composition of the top layer, and any intervening layers between the top structure and the bottom structure, different wavelengths of light may be used, such as UV, visible or IR, so that the bottom layer may be resolved in the image.

The presence of optically opaque materials presents challenges for alignment and overlay. Optically opaque materials, such as metal layers, may be found in a semi-damascene process flow or after the processing of the magnetic tunnel junction (MTJ) of a magnetic random-access memory (MRAM), or other such devices. The presence of an intervening opaque layer between the top structure and the bottom structure of a target will prevent light from reaching the underlying structure, thereby causing the alignment or overlay measurement to fail.

Additionally, during the fabrication process other types of buried structures may be generated, including desired structures, such as lines and vias, and undesired structures, such as inclusions or voids. For example, in advanced packaging processes, wafers may be bonded together, and voids may be formed between the bonded layers, which underlie one or more layers. The presence of voids may affect final performance of the devices, and thus, it is desirable to detect the presence of voids. In some instances, for example, it may be possible to rework the bonded wafers before additional processing is performed, such as polishing, etc. The presence of one or more overlying layers, some of which may be opaque, may reduce the amount of light or prevent light from reaching the buried structures, thereby inhibiting the detection of the presence of the undesired structures. Currently, confocal scanning acoustic microscopy (C-SAM) is sometimes used to detect voids. Unfortunately, for proper conduction of the acoustic signal with C-SAM technology the sample is submerged in water, which is generally undesirable. Moreover, C-Sam technology is not able to image relatively small voids, e.g., sizes below 10 μm, and therefore has limited used.

Laser induced time resolved measurements include, for example, measurements of sample reflectivity, as well as deflection, produced by one or more of opto-acoustic effects, thermal background effects, plasma effects, and any other physical phenomena that produces transient reflectivity or deflection effects in response to light or other radiation. Time resolved reflectivity measurements may be sometimes referred to herein opto-acoustic measurements or measurement of acoustic signals, but unless stated otherwise, reference to acoustic is not intended to be a limitation to the measurement of opto-acoustic effects and may additionally or alternatively include measurement of transient signals due to one or more other physical effects, such as thermal background effects or plasma effects. An example of time resolved reflectivity measurements includes laser induced transient signal measurements such as picosecond laser acoustic (PLA) measurements, which may be used for the measurement of buried structures, e.g., structures that are below one or more layers, e.g., for measurement of alignment or overlay targets that include one or more intervening opaque layers between the top structure and the bottom structure of a target or the detection or measurement of undesired voids or inclusions. If the buried structures underlie one or more opaque layers, the use of opto-acoustic measurements may be particularly advantageous as it does not rely on light to penetrate the opaque layers, but instead generates and detects acoustic waves that are capable of propagating through optically opaque layers. A time resolved reflectivity metrology device, such as PLA, for example, may use an ultrafast laser (˜100 fs pulse width) allowing resolution of a few fs.

In operation, a conventional time resolved reflectivity metrology device may use a local raster scan to map the approximate region of the underlying structure. For time resolved reflectivity measurements, the appropriate time delay plane containing the relevant image information to determine the position of the structure can be defined with a temporal scan limited to, e.g., less than 50 ps, based on knowledge of the device parameters, e.g., layout and film stack information (including the approximate layer materials and thicknesses). The time delay span, the raw acoustic data, its Fourier transform, or the thermal background, or a combination thereof, for a plurality of measurement sites may be used alone or in conjunction with a principal component analysis (PCA) algorithm to form an image of the structure from which the position of the underling structure may be derived. Additionally or alternatively, a non-PCA analysis may be used to identify a localized region in frequency space that captures the signal difference between regions on and off the underlying structure and to seek a highly correlating localized region in temporal space.

The use of a raster scan (or other similar type of scan) requires movement of the sample and/or the metrology head, in the X and Y (or R-θ) directions and separately measuring each site to obtain a two-dimensional (2D) image of the underlying structure. The throughput of the mapping method is dictated by the number of sites in the scan, as well as the extent, resolution, and number of sweeps collected at each site. In some instances, the use of a raster scan of time resolved reflectivity measurements to generate a 2D image of an underlying structure may take up to several minutes or hours. To incorporate the use of time resolved reflectivity measurements for 2D imaging into a high volume manufacturing (HVM) environment, the total imaging time should be approximately a few seconds.

As discussed herein, time resolved reflectivity measurements, including picosecond laser acoustic (PLA) measurements, may use a camera that is configured for parallel acquisition of transient signals using a multi-pixel array and independent phase locking for each pixel in the multi-pixel array. A pump arm in an time resolved reflectivity measurement device is configured to irradiate a target sample with at least one pump pulse to cause transient perturbation in the target material and a probe arm is configured to irradiate the target sample with at least one probe pulse to produce reflected probe pulses that are modulated based on the transient perturbation in the target material. One or more modulators may be used to modulate, e.g., frequency modulation, the pump pulses, the probe pulses, or both pump pulses and the probe pulses. The camera with a multi-pixel array and independent phase locking for each pixel in the multi-pixel array, receives and demodulates the reflected probe pulses to generate images of the sample, each image is a function of a different time delay between the pump pulses and probe pulses. The camera, for example, may record a change in reflectivity or surface deformation of the target sample at every pixel as a function of the time delay between the pump pulses and the probe pulses, with which at least one property of the target sample may be characterized, such as overlay, alignment, or presence of undesired structures such as inclusions or voids. The focused pump and probe beams may cover an area of the target sample that includes the structure to be imaged. The focal area of the pump and probe beams, for example, may be adjusted to be of the order of several tens of microns to include the structure to be imaged. Accordingly, structures with dimensions that are equivalent to the focal area of the pump and probe beams may be imaged without scanning, thereby significantly reducing the total imaging time, e.g., to several seconds as opposed to several minutes or hours as would be required if scanning were used. Moreover, an underlying structure may be three-dimensionally imaged based on a plurality of images produced with different time delays between the pump pulses and the probe pulses.

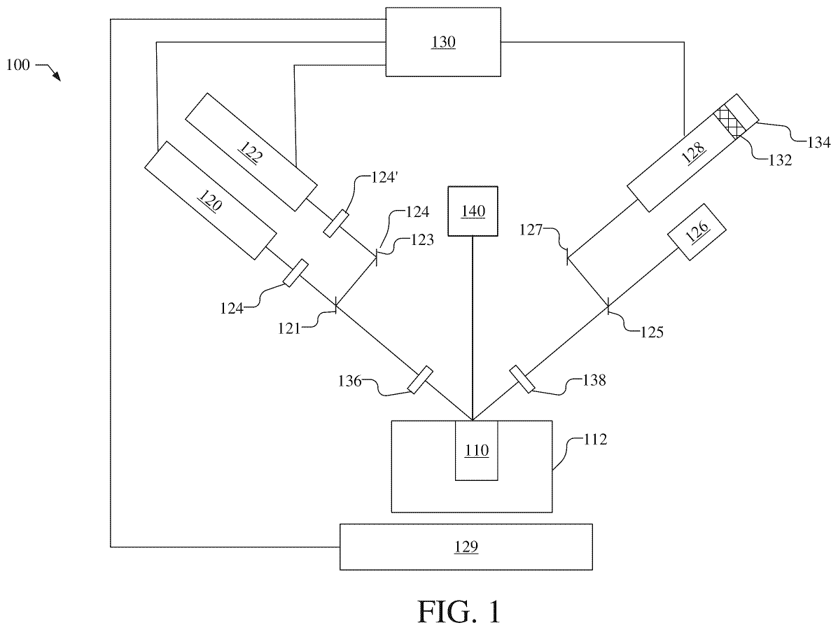

FIG. 1 illustrates a block diagram of an example time resolved reflectivity metrology device 100 that may use a camera that is configured for parallel acquisition of transient signals using a multi-pixel array and independent phase locking for each pixel in the multi-pixel array, as discussed herein. In general, the device 100 includes a pump laser 120 (also referred to herein as an excitation laser), a probe laser 122 (also referred to herein as a detection laser), and optics, such as turning mirror 123 and beam splitter 121, as well as lenses 136 and 138, filters, polarizers and the like (not shown) that direct radiation from the pump and probe lasers 120, 122 over an area of the substrate 112 that includes a structure 110 to be imaged. The device may further include a modulator 124, e.g., such as an electro-optic modulator (EOM), that modulate the pump pulses in the pump arm with a modulation frequency, and in some implementations, a second modulator 124′ that modulates the probe pulses in the probe arm with a different modulation frequency. The device 100 may include optics such as beam splitter 125 and turning mirror 127 and may include a beam dump 126 for capturing radiation from the pump laser returned from the structure 110. The device 100 includes a camera 128 that includes a multi-pixel array 132 and independent phase locking for each pixel in the multi-pixel array and is configured to record a change in reflectivity or surface deformation of the substrate 112 at every pixel as a function of a time delay between the pump pulses and the probe pulses. The device 100 further includes a mechatronic support 129 for a substrate 112 of which structure 110 is a part, the mechatronic support 129 being adapted to move the substrate 112 relative to the pump and probe lasers 120, 122 to obtain measurements from desired positions. The device further includes a processing system 130 coupled to the probe and pump lasers 120, 122, the mechatronic support 129, and the camera 128.

It should be appreciated that the processing system 130 may be a self-contained or distributed computing device capable of performing computations, receiving, and sending instructions or commands and of receiving, storing, and sending information related to the metrology functions of the device.

In the depicted implementation, the pump and probe lasers 120, 122 in the implementation of the time resolved reflectivity metrology device 100 shown in FIG. 1 can share at least a portion of an optical path to and from the structure 110. For example, the lasers can have a number of different relative arrangements including a configuration wherein the paths are the same, partially overlapping, adjacent, or coaxial. In some implementations, the pump and probe beams may be derived from the same pulsed laser. In some implementations, separate lasers may be used for the pump and probe beams, e.g., separate lasers with slightly different repetition rates may be used in an asynchronous optical sampling (ASOPS) configuration. In other implementations, the pump and probe lasers 120, 122 and the beam dump 126 and camera 128 do not share optical paths. For example, the pump beam from the pump laser 120 may be normally incident on the substrate 112, while the probe beam from the problem laser 122 may be obliquely incident on the substrate 112. The pump and probe lasers 120, 122 may be controlled directly so as to obtain the temporal spacing between the pulses of light directed to the structure 110.

It should be appreciated that many optical configurations are possible. In some configurations the pump can be a pulsed laser with a pulse width in the range of several hundred femtoseconds to several hundred nanoseconds and the probe beam is coupled to a beam deflection system. For example, in systems wherein the probe is also pulsed the device can employ a delay stage (not shown) for increasing or decreasing the length of the optical path between the laser and the structure 110 associated therewith. The delay stage, where provided, would be controlled by processing system 130 to obtain and control the time delays between the pump and probe light pulses that are incident on the object. Many other alternative configurations are also possible. In other implementations, such as with an ASOPS configuration, the device may not include a delay stage. It should be appreciated that the schematic illustration of FIG. 1 is not intended to be limiting, but rather depict one of a number of example configurations for the purpose of explaining the new features of the present disclosure.

In operation, the time resolved reflectivity metrology device 100 directs a series of pulses of light from pump laser 120 to the structure 110. These pulses of light are incident (i.e., at an angle which can be any angle between zero to 90 degrees including, for example, 45 degrees and 90 degrees) upon and at least partially absorbed by a transducer layer in the structure 110. The absorption of the light by the transducer layer causes a transient expansion in the material of the structure 110. The expansion is short enough that it induces what is essentially an ultrasonic wave that propagates vertically through the structure 110 and is reflected at each underlying interface in the film stack and returned to the top surface. Light from the pump laser 120 that is reflected from the structure 110 is passed into a beam dump 126 which extinguishes or absorbs the pump radiation.

In addition to directing the operation of the pump laser 120, the processing system 130 directs the operation of the probe laser 122. Probe laser 122 directs radiation in a series of light pulses that is incident on the structure 110, which reflect from the top layer of the structure 110 and is affected by the reflected ultrasonic waves they return to the top surface of the structure 110.

FIG. 1 illustrates modulator 124 that modulate the pump pulses from the pump laser 120, and modulator 124′ to additionally modulate the probe pulses from the probe laser 122. The modulator 124 and 124′, for example, may be EOMs, and may modulate a frequency of the pump pulses or both the pump pulses and the probe pulses, e.g., with two frequency combs.

The device 100 includes optics, such as lens 136, that may be configured to adjust the spot sizes of the pump beam and probe beam based upon the particular target to be measured. The spot sizes of the respective beams may be similar or dissimilar. For example, the optics, such as lens 136, may be configured to adjust a focal area of the pump pulses and the probe pulses on the substrate 112 to at least the size of dimensions of the structure 110 being measured so that the structure 110 may be measured without scanning. For example, the focal area on the substrate 112 may be greater than 20 μm in diameter. The spot size of the pump beam and probe beam may be in part based upon the size of the structure being measured or upon a balance between signal strength and thermal budget of the structure under test.

The light reflected from the surface of the structure 110 is directed from the structure 110, e.g., by means of beam splitter 125 and the probe beam is imaged by the camera 128. The reflectivity of the reflected light, for example, at the top surface is altered due to changes in reflectivity or surface deformation due to the reflected ultrasonic waves returning at the top surface. Where there are transparent layers, the reflected light may interfere constructively and destructively as the ultrasonic wave propagates producing interference oscillations. The camera 128 may be configured to receive and demodulate the reflected probe pulses to generate images of the substrate 112 to sense a change in the intensity of the probe beam of light caused by the changes in reflectivity and/or interference oscillations.

The camera 128 includes a multi-pixel array 132 that receives the probe beam. The optics, such as lens 138, may adjust the magnification of the probe beam on the multi-pixel array 132 for efficiency. The camera 128 may include a parallel phase-locking circuit 134 that is configured for independent phase locking for each pixel in the multi-pixel array for parallel acquisition of transient signals, such as acoustic signals or thermal background signals, to generate the images of the substrate 112. In some implementations, the parallel phase-locking circuit 134 may be independent of the camera 128, e.g., in a separate processor or Field Programmable Gate Array (FPGA). The independent phase locking for each pixel in the multi-pixel array 132 may be used to demodulate the frequency of the pump pulses in the received probe beam. If both the pump pulses and probe pulses are modulated by modulators 124 and 124′, respectively, a combination, e.g., a sum or difference, of the frequencies in the received probe beam may be demodulated. The camera 128 may record a change in reflectivity or surface deformation of the substrate 112 at every illuminated pixel of the multi-pixel array 132 as a function of a time delay between the pump pulses and the probe pulses. For example, the camera 128 may generate a plurality of images of the substrate 112 with each image produced with a different time delay between the pump pulse and the probe pulse. For example, the camera 128 may be configured to generate in-phase measurements and to generate quadrature measurements.

The pump pulses and probe pulses may be produced with different delays, and the camera 128 may generate images of the sample with each image produced with a different time delay between the pump pulses and probe pulses. Each image generated by the camera 128, for example, may correspond to an arrival of transient signals, such as acoustic echoes or thermal background, from underlying layers at different depths within the patterned structure, with which desired or undesired structures in the underlying layers may be detected.

In addition, the time resolved reflectivity metrology device 100 may be coupled with an imaging device 140 that is configured to image the top structure on the film stack, e.g., for alignment or overlay purposes. The imaging device 140, for example, may be the navigation channel camera. The imaging device 140 may perform optical imaging of the structure 110. Due to one or more opaque layers in the structure 110, however, the optical image of the structure 110 produced by the imaging device 140 may include only the top structure.

When the focused probe beam covers an area of the substrate 112 that includes an underlying structure 110 with a surrounding background, the camera 128 generates an image with a particular time delay that corresponds to the arrival of the transient signals from the structure, which is a representative image of the underlying structure 110. The focal area of the pump beam and probe beam produced by optics, such as lens 136, may be adjusted to be of the order of several tens of microns. Accordingly, structures with dimensions equivalent to the beam focal area can be imaged without the need to perform a raster scan, thereby reducing the total imaging time down considerably, e.g., to several seconds, from several minutes or hours for a raster scan. Moreover, structures significantly smaller than the beam focal area, e.g., structures the size of or less than a pixel or less 10 μm, may be detected.

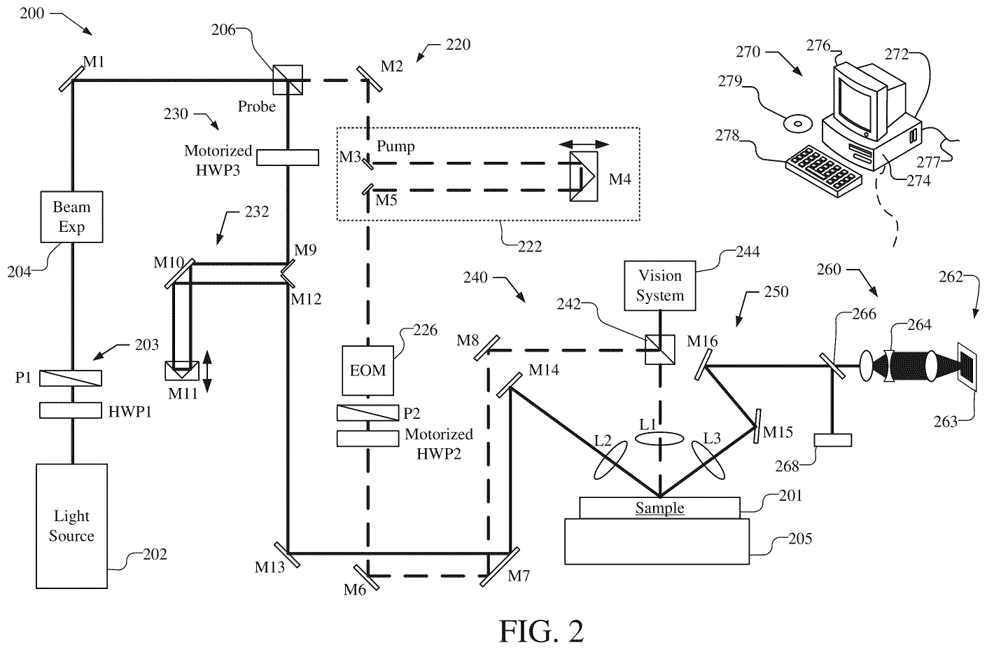

FIG. 2 illustrates a schematic representation of an example time resolved reflectivity metrology device 200 that may use a camera that is configured for parallel acquisition of transient signals using a multi-pixel array and independent phase locking for each pixel in the multi-pixel array, as discussed herein. As illustrated, light may be produced from a light source 202, such as a 520 nm, 200fs, 60 MHz laser. Other light source characteristics, however, may be used, including light sources that operate in the infrared wavelength ranges, e.g., for imaging buried structures. The light is directed through an intensity control 203, which may include a half wave plate HWP1 and a polarizer P1, and may be directed through a beam expander 204. The beam may be directed by mirror M1 to pump probe separator 206, which may include a polarizing beam splitter.

In the pump arm 220, the pump beam is directed by mirror M2 to a variable delay 222 that includes mirrors M3, M4, and M5, where mirror M4 moves to adjust the delay in the pump beam. The mirror M4, for example, may be a retroreflector or mirror coupled to an actuator or voice coil VC with a physical displacement of, e.g., approximately 25 mm or 83.3 ps for achieving a short repeatable pump pulse time delay. The pump beam passes through a modulator 226, e.g., an electro-optic modulator (EOM), followed by a polarizer P2 and a half wave plate HWP2, which may be motorized to rotate. The pump beam is directed by beam steering mirrors, e.g., mirrors M6, M7, and M8, to a focusing unit 240. At least one of the mirrors M6, M7, and M8 may be attached to a piezoelectric motor to adjust the direction of the pump beam. As illustrated in FIG. 2, the focusing unit 240 may include a beam splitter 242 that directs the pump beam through lens L1 to be normally incident on the sample 201. The lens L1 focuses the pump beam over an area of the sample 201 that includes the structure to be imaged. In some implementations, the pump beam may be directed to be obliquely incident on the sample 201, e.g., along the same beam path as the probe beam.

In the probe arm 230, after the pump probe separator 206, the probe beam may pass through a half wave plate HWP2, which may be motorized to rotate. The probe beam may be directed to a probe delay 232 that includes mirrors M9, M10, M11, and M12. The mirror M11, for example, may be a retroreflector and may be a coupled to an actuator or voice coil to adjust the delay of the probe beam. The probe beam is directed by beam steering mirrors, e.g., mirrors M13, M7, M14, to the focusing unit 240. At least one of the mirrors M13, M7, and M14 may be attached to a piezoelectric motor to adjust the direction of the probe beam. As illustrated in FIG. 2, the focusing unit 240 may direct the probe beam through lens L2 to be obliquely incident on the sample 201. The lens L2 focuses the probe beam over an area of the sample 201 that includes the structure to be imaged and that is coincident with the area of incidence of the pump beam. In some implementations, similar to the pump beam, the probe beam may pass through a modulator, e.g., an EOM, followed by a polarizer and a half wave plate, which may be motorized to rotate, to modulate the frequency of the probe beam, e.g., with a different frequency comb than the pump beam.

The lenses L1 and L2, for example, may be configured to generate coincident spots on the sample 201 that are at least a size of dimensions of a structure under test on the sample 201 so that scanning is not required to image the desired structure, such as an alignment or overlay pattern. In some implementations, for example, the lenses L1 and L2 may have a focal area greater than 20 μm.

The variable delay 222 and the probe delay 232 may be operated in an absolute or relative (with fixed amplitude and a sinusoidal waveform) displacement mode. For example, due to local topography and film thickness variation, localization in time delay may have poor capability preventing a faster scan. Data may be collected at a fixed position with a fixed amplitude (1.5 mm) sinusoidal oscillation at a frequency (10 KHz) of the retroreflector M14 on the voice coil yielding a delay of +/−5 ps. With the time constant optimized on the lock-in amplifiers for the sinusoidal oscillation, the voltage output may then be the average of the change in reflectivity over the selected time delay range mitigating the noted concern of operating at a fixed position.

The reflected probe beam (and optionally reflected pump beam if obliquely incident) is received by a collection optics 250 that includes, e.g., lens L3 and mirrors M15 and M16. The reflected beam is directed to a detection unit 260 that includes a camera 262 with a multi-pixel array 263. In some implementations, the detection unit 260 may additionally include a flip mirror 266 or beam splitter that may be used to selectively direct the reflected beam to a detector 268. The reflected beam, for example, may be received by the camera 262 via relay lenses 264 and imaged on a multi-pixel array 263. The optics, e.g., relay lenses 264 may adjust the magnification of the probe beam on the multi-pixel array 263 for improved efficiency. The camera 262 is configured for independent phase locking for each pixel in the multi-pixel array 263 for parallel acquisition of transient signals from the images of the sample 201, such as acoustic signals or thermal background signals. The independent phase locking for each pixel in the multi-pixel array 263 may be used to demodulate the received probe beam based on the frequency of the pump pulses, or the combination of frequencies in both the pump pulses and probe pulses, produced by the modulator 226 (and modulator in the probe arm 230 if present). In implementations in which both the pump pulses in the pump beam and probe pulses in the probe beam are modulated with two different frequency combs (e.g., by modulators in both pump arm 220 and probe arm 230), the independent phase locking for each pixel in the multi-pixel array 263 may be used to demodulate the combination, e.g., sum or difference, of the frequencies. Moreover, the independent phase locking for each pixel in the multi-pixel array 263 may generate in-phase measurements and quadrature measurements from the images. The camera 262 may record a change in reflectivity or surface deformation of the sample 201 at every illuminated pixel of the multi-pixel array 263 as a function of a time delay between the pump pulses and the probe pulses.

The pump pulses and probe pulses may be produced with different time delays and the camera 262 may generate a plurality of images with different time delays. Each image generated by the camera 262 corresponds to an arrival of transient signals, e.g., acoustic echoes or thermal background, from underlying layers within the patterned structure, and different time delays between the pump pulses and probe pulses relate to different depths in the underlying layers. Accordingly, by generating a plurality of images with different time delays between the pump pulses and probe pulses, buried structures at different depths in the underlying layers may be detected.

In addition, the time resolved reflectivity metrology device 200 may be coupled with an imaging device 244 that may be configured to image the top structure of the sample 201 via beam splitter 242 and lens L1. The imaging device 244, for example, may be the navigation channel camera.

The sample 201 is held on a stage 205 that includes or is coupled to one or more actuators configured to move the sample 201 relative to the optical system of the time resolved reflectivity metrology device 200 so that various locations on the sample 201 may be measured. In the depicted implementation, the device may include additional components and subsystems, such as beam management and conditioning components, such as beam expanders, collimators, polarizers, half-wave plates, etc., as well as a beam power detector, and a height detector. Those having skill in the art will appreciate variations of the devices depicted in FIGS. 1 and 2 that would still be suitable to carry out the time resolved reflectivity metrology techniques described herein.

The camera 262, as well as other components of the time resolved reflectivity metrology device 200, such as the detector 268, light source 202, variable delay 222, stage 205 upon which the sample 201 is held, may be coupled to a processing system 270, such as a workstation, a personal computer, central processing unit or other adequate computer system, or multiple systems. It should be understood that one processor, multiple separate processors or multiple linked processors may be used, all of which may interchangeably be referred to herein as processing system 270. The processing system 270 is preferably included in, or is connected to, or otherwise associated with time resolved reflectivity metrology device 200. The processing system 270, for example, may control the positioning of the sample 201, e.g., by controlling movement of the stage 205 on which the sample 201 is held. The stage 205, for example, may be capable of horizontal motion in either Cartesian (i.e., X and Y) coordinates, or Polar (i.e., R and θ) coordinates or some combination of the two. The stage 205 may also be capable of vertical motion along the Z coordinate. The processing system 270 may further control the operation of a chuck on the stage 205 used to hold or release the sample 201. The processing system 270 may also collect and analyze the data obtained from the camera 262, detector 268 and imaging device 244. The processing system 270 may analyze the time resolved reflectivity metrology data to determine a location of a structure in the sample 201, which may be below one or more optically opaque layers, and may further analyze the imaging data to determine a location of the top structure of the target, from which the relative position of the top structure with respect to the bottom structure may be determined from which the alignment or overlay may be determined. For example, in some implementations, an underlying structure may be three-dimensionally imaged based on a plurality of the images produced with different time delays between the pump pulses and the probe pulses. The processing system 270 may use the measured data for localized mapping of the buried structure, e.g., using one or more images acquired by the camera 262. For example, if the spot size of the pump and probe beams covers a buried structure under test, such as an overlay target, then only a single image may be used. If, however, the structure is larger than the spot size, or if the spot does not correctly align with the structure, multiple images may be acquired by the camera 262 and stitched together. If the buried structure is relatively small, e.g., dimensions the size of a pixel or sub-pixel of the camera 262, such as voids or inclusions, with the use of camera 262, multiple structures may be measured or detected over a large area of the sample simultaneously. Using the raw time resolved reflectivity metrology data, or processed data, such as its Fourier transform, or the thermal background, or a combination thereof, in the one or more images of the structure, the position of the underling structure may be derived. In some implementations, a principal component analysis (PCA) process may be used with the data from the one or more images of the structure. Additionally or alternatively, a non-PCA analysis may be used to identify a localized region in frequency space that captures the signal difference between regions on and off the underlying structure and to seek a highly correlating localized region in temporal space. The processing system 270 may alternatively or additional process the time resolved reflectivity metrology data for edge detection or triangulation, e.g., using a classification library or neural network generated by the time resolved reflectivity metrology device 200 (or another device) on a reference sample. The classification library, for example, may be built based on the time resolved reflectivity measurement data that is collected from locations on and off the bottom structure of a reference target. The classification library (or neural network) may be used with one or more time resolved reflectivity measurements at locations at the approximate region of the bottom structure to determine whether each location is on or off the bottom structure. Additional time resolved reflectivity measurements may be acquired at new positions and compared to the classification library as dictated by a predefined search pattern or algorithm until one or more edges of the bottom structure are located, from which the position of the bottom structure may be determined.

The processing system 270, which includes at least one processor 272 with memory 274, as well as a user interface including e.g., a display 276 and input devices 278. A non-transitory computer-usable storage medium 279 having computer-readable program code embodied may be used by the processing system 270 for causing the processing system 270 to control the time resolved reflectivity metrology device 200 and to perform the functions including the analysis described herein. The data structures, classification library, software code, etc., for automatically implementing one or more acts described in this detailed description can be implemented by one of ordinary skill in the art in light of the present disclosure and stored, e.g., on a computer-usable storage medium 279, which may be any device or medium that can store code and/or data for use by a computer system such as the at least one processor 272. The computer-usable storage medium 279 may be, but is not limited to, flash drive, magnetic and optical storage devices such as disk drives, magnetic tape, compact discs, and DVDs (digital versatile discs or digital video discs). A communication port 277 may also be used to receive instructions that are used to program the processing system 270 to perform any one or more of the functions described herein and may represent any type of communication connection, such as to the internet or any other computer network. The communication port 277 may further export signals, e.g., with alignment or overlay measurement results and/or instructions, to another system, such as external process tools, in a feed forward or feedback process in order to adjust a process parameter associated with a fabrication process step of the samples based on the measurement results. Additionally, the functions described herein may be embodied in whole or in part within the circuitry of an application specific integrated circuit (ASIC) or a programmable logic device (PLD), and the functions may be embodied in a computer understandable descriptor language which may be used to create an ASIC or PLD that operates as herein described. The results from the analysis of the data may be stored, e.g., in memory 274 associated with the sample and/or provided to a user, e.g., via display 276, an alarm or other output device. Moreover, the results from the analysis may be fed back to the process equipment to adjust the appropriate patterning step to compensate for any detected misalignment or overlay error in the multiple patterning process.

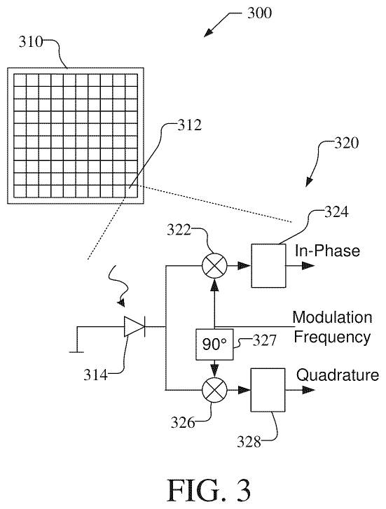

FIG. 3 illustrates a schematic representation of a camera 300 configured for parallel acquisition of transient signals, such as acoustic signals or thermal background signals, using a multi-pixel array 310 and independent phase locking for each pixel in the multi-pixel array 310. The camera 300, for example, may be used as camera 128 in FIG. 1 or camera 262 in FIG. 2, and is configured for parallel acquisition of transient signals to generate the images of the sample.

FIG. 3, for example, illustrates a close up view of a single pixel 312 in the multi-pixel array 310, which is illustrated as including a photodiode 314 and an associated phase locking circuit 320. Each pixel in the multi-pixel array 310 may be associated with an independent phase locking circuit. The phase locking circuits may be part of the camera 300 or may be separate from the camera, e.g., in a separate processor or FPGA.

As illustrated, the phase locking circuit 320 associated with the photodiode 314 (for pixel 312 in the multi-pixel array 310) may be configured to generate in-phase measurements and to generate quadrature measurements. The signal from the photodiode 314, for example, is multiplied at multiplier 322 by the modulation frequency, followed by filtering by a low pass filter 324, to generate the in-phase measurement. The modulation frequency, for example, may be provided by a local oscillator, and is the modulation frequency applied to the pump beam, probe beam or both. Additionally, the signal from the photodiode 314 may be multiplied at multiplier 326 by the modulation frequency (e.g., from a local oscillator) shifted 90° by shifter 327, followed by filtering by the low pass filter 328, to generate the quadrature measurement.

In operation, pump pulses are modulated, or both the pump pulses and the probe pulses are modulated with different frequencies, e.g., using one or more modulators (e.g., modulators 124, 124′, 226 in FIGS. 1 and 2). The camera 300 receives the reflected probe pulses with the multi-pixel array 310 which is modulated based on the modulation of the pump pulses or based on the combined modulation of the pump pulses and the probe pulses, and independently demodulates each pixel to generate images of the sample, with each image being a function of a different time delay between the pump pulses and the probe pulses. For example, if the both the pump pulses and the probe pulses are modulated, the received probe beam is demodulated based on the combination, e.g., sum or difference, of the modulation frequencies of the pump beam and probe beam. The camera 300 may record a change in reflectivity or surface deformation of the sample at every pixel of the images as a function of the time delay between the pump pulses and the probe pulses, with which at least one property of the sample may be characterized.

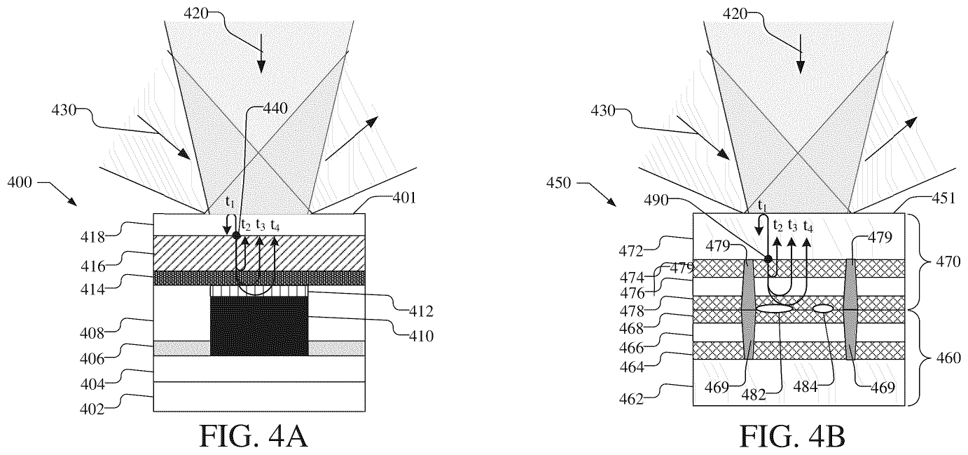

FIG. 4A, by way of example, illustrates a measurement of a sample using parallel acquisition of transient signals using a multi-pixel array and independent phase locking for each pixel in the multi-pixel array, as discussed herein. FIG. 4A, for example, illustrates a sample 400 including a buried tungsten (W) structure 410. The sample 400, for example, includes a substrate 402 with a silicon oxide (SiO₂) layer 404, a silicon carbon nitride (SiCN) layer 406, a SiO₂ layer 408 with the W structure 410 that is buried by a tantalum nitride (TaN) layer 412, a magnetic tunnel junction (MTJ) layer 414, a titanium nitride (TiN) layer 416, and SiO₂ layer 418. It should be understood that sample 400 is merely an example, and other types of samples may be measured, including samples with additional or fewer layers and samples with different types of layers or structures. As illustrated, a pump beam 420 may be normally incident on the surface 401 of the sample 400 and a probe beam 430 is obliquely incident and reflected off the surface 401 of the sample 400. Additionally, as illustrated, by a single point 440 (e.g., corresponding to a single pixel of a camera, such as a camera 300 shown in FIG. 3), transient signals in the form of acoustic reflections occur at a number of different interfaces, which may be detected by the camera 300 at different times. For example, at time t₁ the transient signal from the surface 401 may be detected, while at times t₂, t₃, and t₄ the transient signals from the interfaces between layers 416 and 414; layer 414 and 412; and layer 412 and W structure 410, respectively. It should be understood that although FIG. 4A illustrates the transient signals received at a single point 440, the pump beam 420 and probe beam 430 are incident over an area that is comparably sized to the W structure 410 and accordingly, transient signals are similarly received over the entire area of the incident beams, which may be acquired in parallel by the multi-pixel array of the camera.

FIG. 4B, by way of example, illustrates another example of a measurement of a sample using parallel acquisition of transient signals using a multi-pixel array and independent phase locking for each pixel in the multi-pixel array, as discussed herein. FIG. 4B, for example, illustrates a sample 450 including two bonded wafers 460 and 470 having buried voids 482 and 484 disposed between. The wafer 460, for example, includes a silicon substrate 462, a silicon nitride (SiN) layer 464, a silicon oxide (SiO₂) layer 466, SiN layer 468, and copper (Cu) bonding pads 469. The wafer 470 is similar to wafer 460, but is inverted, with silicon substrate 472, SiN layer 474, SiO₂ layer 476, SiN layer 478, and Cu bonding pads 479. As illustrated, voids 482 and 484 are disposed between SiN layers 468 and 478. It should be understood that sample 450 is merely an example, and other types of samples may be measured, including samples with additional or fewer layers and samples with different types of layers or structures. As discussed in FIG. 4A, the pump beam 420 may be normally incident on the surface 451 of the sample 450 and a probe beam 430 is obliquely incident and reflected off the surface 451 of the sample 450. Additionally, as illustrated, by a single point 490 (e.g., corresponding to a single pixel of a camera, such as a camera 300 shown in FIG. 3), transient signals in the form of acoustic reflections or thermal background signals occur at a number of different interfaces, which may be detected by the camera 300 at different times. For example, at time t₁ the transient signal from the surface 401 may be detected, while at times t₂, t₃, and t₄ the transient signals from the interfaces between layers 474 and 476; layers 476 and 478; and layer 478 and void 482, respectively. It should be understood that although FIG. 4B illustrates the transient signals received at a single point 490, the pump beam 420 and probe beam 430 are incident over an area that includes multiple voids, illustrated by voids 482 and 484, and transient signals are similarly received over the entire area of the incident beams, which may be acquired in parallel by the multi-pixel array of the camera enabling simultaneous detection of the presence of both voids 482 and 484.

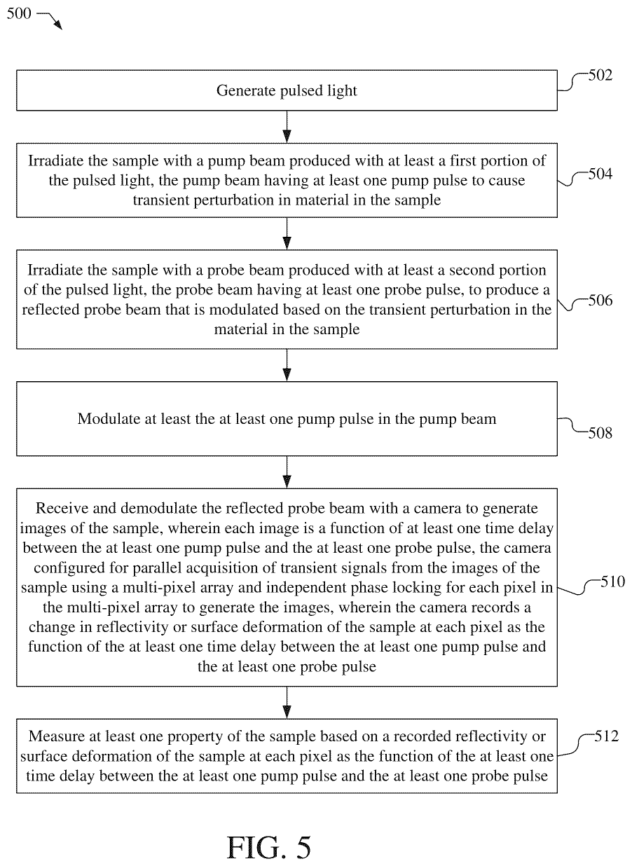

FIG. 5 is a flow chart 500 illustrating a process of non-destructive time resolved reflectivity metrology of a target on a sample with a camera configured for parallel acquisition of transient signals using a multi-pixel array and independent phase locking for each pixel in the multi-pixel array, as discussed herein. The process, for example, may be performed using time resolved reflectivity metrology devices 100 or 200 shown in FIG. 1 or 2, respectively, or the camera 300 shown in FIG. 3.

As illustrated, at block 502, the process includes generating pulsed light, e.g., as discussed in reference to pump and probe lasers 120, 122 shown in FIG. 1 and light source 202 shown in FIG. 2.

At block 504, the process includes irradiating the sample with a pump beam produced with at least a first portion of the pulsed light, the pump beam having at least one pump pulse to cause transient perturbation in material in the sample, e.g., as discussed in reference to pump laser 120 shown in FIG. 1 and pump arm 220 shown in FIG. 2.

At block 506, the process includes irradiating the sample with a probe beam produced with at least a second portion of the pulsed light, the probe beam having at least one probe pulse, to produce a reflected probe beam that is modulated based on the transient perturbation in the material in the sample, e.g., as discussed in reference to probe laser 122 shown in FIG. 1 and probe arm 230 shown in FIG. 2.

At block 508, the process includes modulating at least the at least one pump pulse in the pump beam, e.g., as discussed in reference to modulators 124, 124′ shown in FIG. 1 and modulator 226 shown in FIG. 2. In some implementations, the process includes modulating both the at least one pump pulse in the pump beam and the at least one probe pulse in the probe beam, e.g., as discussed in reference to modulators 124, 124′ shown in FIG. 1 and modulator 226 shown in FIG. 2.

At block 510, the process includes receiving and demodulating the reflected probe beam with a camera to generate images of the sample, wherein each image is a function of at least one time delay between the at least one pump pulse and the at least one probe pulse, the camera configured for parallel acquisition of transient signals from the images of the sample using a multi-pixel array and independent phase locking for each pixel in the multi-pixel array to generate the images, wherein the camera records a change in reflectivity or surface deformation of the sample at each pixel as the function of the at least one time delay between the at least one pump pulse and the at least one probe pulse, e.g., as discussed in reference to cameras 128, 262, and 300 shown in FIGS. 1, 2, and 3, respectively.

At block 512, the process includes measuring at least one property of the sample based on a recorded reflectivity or surface deformation of the sample at each pixel as the function of the at least one time delay between the at least one pump pulse and the at least one probe pulse, e.g., as discussed in reference to processing system 130 and 270 shown in FIGS. 1 and 2, respectively. By way of example, in some implementations, the at least one property of the sample may be at least one of alignment, overlay, presence of a void. In some implementations, the at least one property of the sample may include properties of an underlying structure that is three-dimensionally imaged based on the images produced with the at least one time delay between the at least one pump pulse and the at least one probe pulse.

In some implementations, the process may include focusing the pump beam and probe beam on the sample in a focal area greater than 20 μm, e.g., as discussed in reference to lenses 136, L1, and L2 shown in FIGS. 1 and 2. The focal area of the pump beam and the probe beam on the sample, for example, may have a size that is at least the dimensions of a structure under test on the sample, e.g., as discussed in reference to lenses 136, L1, and L2 shown in FIGS. 1 and 2.

In some implementations, the process may further include generating a plurality of images of the sample with the camera, wherein each image is produced with a different time delay between the at least one pump pulse and the at least one probe pulse, e.g., as discussed in reference to cameras 128, 262, and 300 shown in FIGS. 1, 2, and 3, respectively.

In some implementations, the probe beam may be incident on an area of the sample that covers a patterned structure, wherein each image of the sample generated by the camera corresponds to an arrival of acoustic echoes from underlying layers within the patterned structure to detect a buried structure in the underlying layers of the patterned structure, e.g., as discussed in reference to FIGS. 1 and 2.

In some implementations, modulating at least the at least one pump pulse in the pump beam modulates a frequency of the at least one pump pulse in the pump beam, and the independent phase locking for each pixel in the multi-pixel array demodulates the frequency, e.g., as discussed in reference to modulator 124 shown in FIG. 1 and modulator 226 shown in FIG. 2, and cameras 128, 262, and 300 shown in FIGS. 1, 2, and 3, respectively.

In some implementations, modulating at least the at least one pump pulse in the pump beam may include modulating a first frequency of the at least one pump pulse in the pump beam with a first modulator, and modulating a second frequency of the at least one probe pulse with a second modulator, and the independent phase locking for each pixel in the multi-pixel array demodulates a frequency based on a combination of the first frequency and the second frequency, e.g., as discussed in reference to modulator 124 shown in FIG. 1 and modulator 226 shown in FIG. 2, and cameras 128, 262, and 300 shown in FIGS. 1, 2, and 3, respectively.

In some implementations, the process further includes generating in-phase measurements and quadrature measurements from the images of the sample received by the camera, e.g., as discussed in reference to cameras 128, 262, and 300 shown in FIGS. 1, 2, and 3, respectively.

The above description is intended to be illustrative, and not restrictive. For example, the above-described examples (or one or more aspects thereof) may be used in combination with each other. Other implementations can be used, such as by one of ordinary skill in the art upon reviewing the above description. Also, in the above Description, various features may be grouped together to streamline the disclosure. The inventive subject matter may lie in less than all features of a particular disclosed implementation. Thus, the following aspects are hereby incorporated into the Description as examples or implementations, with each aspect standing on its own as a separate implementation, and it is contemplated that such implementations can be combined with each other in various combinations or permutations. Therefore, the spirit and scope of the appended claims should not be limited to the foregoing description.

What is claimed is:

1. A metrology device for non-destructive metrology of a sample, comprising:
a light source for generating pulsed light;
a pump arm that is configured to receive at least a first portion of the pulsed light and irradiate the sample with a pump beam having at least one pump pulse to cause transient perturbation in material in the sample;
a probe arm that is configured to receive at least a second portion of the pulsed light and irradiate the sample with a probe beam having at least one probe pulse to produce a reflected probe beam that is modulated based on the transient perturbation in the material in the sample;
at least one modulator that modulates at least the at least one pump pulse in the pump beam;
a camera configured to receive and demodulate the reflected probe beam to generate images of the sample, wherein each image is a function of at least one time delay between the at least one pump pulse and the at least one probe pulse, the camera configured for parallel acquisition of transient signals from the sample using a multi-pixel array and independent phase locking for each pixel in the multi-pixel array to generate the images, the camera records a change in reflectivity or surface deformation of the sample at each pixel as the function of the at least one time delay between the at least one pump pulse and the at least one probe pulse; and
at least one processor coupled to the camera and configured to measure at least one property of the sample based on a recorded reflectivity or surface deformation of the sample at each pixel as the function of the at least one time delay between the at least one pump pulse and the at least one probe pulse.

2. The metrology device of claim 1, wherein the at least one property of the sample comprises properties of an underlying structure that is three-dimensionally imaged based on the images produced with different time delays between the at least one pump pulse and the at least one probe pulse.

3. The metrology device of claim 1, wherein the at least one property of the sample comprises at least one of alignment, overlay, presence of a void.

4. The metrology device of claim 1, further comprising optics configured to adjust a focal area of the pump beam and the probe beam on the sample to greater than 20 μm.

5. The metrology device of claim 4, wherein the focal area of the pump beam and the probe beam on the sample is at least a size of dimensions of a structure under test on the sample.

6. The metrology device of claim 1, wherein the camera generates a plurality of images of the sample, wherein each image is produced with a different time delay between the at least one pump pulse and the at least one probe pulse.

7. The metrology device of claim 1, wherein the probe beam is incident on an area of the sample that covers a patterned structure, wherein each image of the sample generated by the camera corresponds to an arrival of acoustic echoes from underlying layers within the patterned structure to detect a buried structure in the underlying layers of the patterned structure.

8. The metrology device of claim 1, wherein the at least one modulator modulates a frequency of the at least one pump pulse in the pump beam, and the independent phase locking for each pixel in the multi-pixel array demodulates the frequency.

9. The metrology device of claim 1, wherein the at least one modulator comprises a first modulator that is configured to modulate a first frequency of the at least one pump pulse in the pump beam, and a second modulator that is configured to modulate a second frequency of the at least one probe pulse in the probe arm, and wherein the independent phase locking for each pixel in the multi-pixel array demodulates a frequency based on a combination of the first frequency and the second frequency.

10. The metrology device of claim 1, wherein the camera is configured to generate in-phase measurements and to generate quadrature measurements.

11. A method for non-destructive metrology of a sample, comprising:
generating pulsed light;
irradiating the sample with a pump beam produced with at least a first portion of the pulsed light, the pump beam having at least one pump pulse to cause transient perturbation in material in the sample;
irradiating the sample with a probe beam produced with at least a second portion of the pulsed light, the probe beam having at least one probe pulse, to produce a reflected probe beam that is modulated based on the transient perturbation in the material in the sample;
modulating at least the at least one pump pulse in the pump beam;
receiving and demodulating the reflected probe beam with a camera to generate images of the sample, wherein each image is a function of at least one time delay between the at least one pump pulse and the at least one probe pulse, the camera configured for parallel acquisition of transient signals from the sample using a multi-pixel array and independent phase locking for each pixel in the multi-pixel array to generate the images, wherein the camera records a change in reflectivity or surface deformation of the sample at each pixel of the images as the function of the at least one time delay between the at least one pump pulse and the at least one probe pulse; and
measuring at least one property of the sample based on a recorded reflectivity or surface deformation of the sample at each pixel as the function of the at least one time delay between the at least one pump pulse and the at least one probe pulse.

12. The method of claim 11, wherein the at least one property of the sample comprises properties of an underlying structure that is three-dimensionally imaged based on the images produced with different time delays between the at least one pump pulse and the at least one probe pulse.

13. The method of claim 11, wherein the at least one property of the sample comprises at least one of alignment, overlay, presence of a void.

14. The method of claim 11, further comprising focusing the pump beam and the probe beam on the sample in a focal area greater than 20 μm.

15. The method of claim 14, wherein the focal area of the pump beam and the probe beam on the sample is at least a size of dimensions of a structure under test on the sample.

16. The method of claim 11, further comprising generating a plurality of images of the sample with the camera, wherein each image is produced with a different time delay between the at least one pump pulse and the at least one probe pulse.

17. The method of claim 11, wherein the probe beam is incident on an area of the sample that covers a patterned structure, wherein each image of the sample generated by the camera corresponds to an arrival of acoustic echoes from underlying layers within the patterned structure to detect a buried structure in the underlying layers of the patterned structure.

18. The method of claim 11, wherein modulating at least the at least one pump pulse in the pump beam modulates a frequency of the at least one pump pulse in the pump beam, and the independent phase locking for each pixel in the multi-pixel array demodulates the frequency.

19. The method of claim 11, wherein modulating at least the at least one pump pulse in the pump beam comprises modulating a first frequency of the at least one pump pulse in the pump beam with a first modulator, and modulating a second frequency of the at least one probe pulse with a second modulator, and wherein the independent phase locking for each pixel in the multi-pixel array demodulates a frequency based on a combination of the first frequency and the second frequency.

20. The method of claim 11, generating in-phase measurements and quadrature measurements from the images of the sample received by the camera.
